(19) United States
(12) Patent Application Publication
(10) Pub. No.: US 2025/0376040 A1
(43) Pub. Date: Dec. 11, 2025

(54) BOOM CONSTRUCTION FOR DYNAMIC ENERGY TRANSFER SYSTEM

(71) Applicant: Caterpillar Inc., Peoria, IL (US)

(72) Inventors: Igor STRASHNY, Tucson, AZ (US); Nitin R. PATEL, Tucson, AZ (US); Jason R. SCHAFER, Rapid City, SD (US); Kurt L. WINCKLER, Tucson, AZ (US); Stephen HERD, Durham (GB)

(73) Assignee: Caterpillar Inc., Peoria, IL (US)

(21) Appl. No.: 19/228,177

(22) Filed: Jun. 4, 2025

Related U.S. Application Data
(60) Provisional application No. 63/657,146, filed on Jun. 7, 2024.

(51) Int. Cl. B60L 5/38

(52) U.S. Cl. CPC B60L 5/38; B60L 2200/40

(57) ABSTRACT

In one aspect, a boom assembly for a mobile machine includes a front end and a rear end, and further includes an extendable and retractable boom. The boom includes a first end, a second end, a top wall extending from the first end to the second end, and a bottom wall extending from the first end and the second end, the bottom wall being opposed to the top wall, and a central wall. The central wall connects the top wall and the bottom wall so as to form a front compartment on one side of the central wall, and a rear compartment on a second side of the central wall, when the boom is in an extended position. A component of an actuator system is connected to the central wall and located within the rear compartment.

### CROSS-REFERENCE TO RELATED APPLICATION

This application claims the benefit of priority to U.S. Provisional Patent Application No. 63/657,146, filed on Jun. 7, 2024, the entirety of which is incorporated herein by reference.

### TECHNICAL FIELD

The present disclosure relates generally to a boom structure for a mobile machine, and more specifically, to a pivoting boom for connecting an electrically-powered machine to an electrically-conducting rail system.

### BACKGROUND

Mobile industrial machines, including hauling machines, can be of substantial weight and designed to bear immense loads, thus requiring a significant amount of power. Many industrial machines are driven by internal combustion engines. However, internal combustion engines have drawbacks in the form of fuel costs, fuel transport difficulties, and detrimental engine emissions, among others. Accordingly, there has been a movement toward powering large mobile industrial machines with partial or all-electric power systems.

While partial-electric and all-electric power systems for industrial machines are beneficial for alleviating fuel costs and emission issues, these systems present unique challenges. For example, the use of partial-electric or all-electric systems in an industrial capacity involves significant investment in infrastructure, such as the installation of overhead electric rails. While overhead electricity-conducting rails are useful in some circumstances, freely-steerable industrial machines and worksites with uneven terrain can cause the installation of overhead rails to be difficult or even impractical. Also, as industrial machine routes can change due to project needs, machine systems should be designed to account for route changes while remaining capable of securely contacting the rail and conducting power to the mobile machine.

An electric delivery system for providing electric power to a traveling vehicle is disclosed in International Patent App. Pub. No. WO 2020/186296 A1, published on Sep. 24, 2020 (“the '296 publication”). The '296 publication describes an electric delivery system at a mine site for a moving vehicle where two conductors are anchored to relocatable roadside barriers. An arm for contacting conductors can be withdrawn towards the vehicle when not in use. The system described in the '296 publication does not describe a boom for carrying components in a manner that facilitates maintenance, protects components attached to the boom, and that provides the ability to position components (e.g., hydraulic, pneumatic, electrical, or computational) in a desired manner.

Aspects of the present disclosure may solve one or more of the problems set forth above and/or other problems in the art. The scope of the current disclosure, however, is defined by the attached claims, and not by the ability to solve any specific problem.

### SUMMARY

In one aspect, a boom assembly for a mobile machine includes a front end and a rear end, and further includes an extendable and retractable boom. The boom includes a first end, a second end, a top wall extending from the first end to the second end, and a bottom wall extending from the first end and the second end, the bottom wall being opposed to the top wall, and a central wall. The central wall connects the top wall and the bottom wall so as to form a front compartment on one side of the central wall, and a rear compartment on a second side of the central wall, when the boom is in an extended position. A component of an actuator system is connected to the central wall and located within the rear compartment.

In another aspect, an electrically-powered mobile machine having a front end and a rear end, includes at least one motor configured to propel the mobile machine, a conductor assembly configured to connect to an electrically-conductive rail for supplying electrical energy to propel the mobile machine and an extendable and retractable boom. The boom includes a first end, a second end, a top wall extending from the first end to the second end, a bottom wall extending from the first end and the second end, the bottom wall being opposed to the top wall; and, and a central wall connecting the top wall and the bottom wall, so as to form a front compartment on one side of the central wall, and a rear compartment on a second side of the central wall, when the boom is in an extended position. A hydraulic component associated with the conductor assembly is connected to the central wall and located within the rear compartment, and a high voltage component associated with the conductor assembly is connected to the central wall and located within the front compartment.

In yet another aspect, a boom assembly for a mobile machine includes a boom including a first end, a second end, a top wall extending from the first end to the second end, a bottom wall extending from the first end and the second end, the bottom wall being opposed to the top wall, and a connecting wall connecting the top wall and the bottom wall. At least one enclosure is formed by the top wall, the bottom wall, and the connecting wall, and a component associated with a conducing assembly connected to the boom is connected to the top wall, the bottom wall, the front wall, or the rear wall and secured inside the enclosure.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a perspective view of an electrically-powered mobile machine connected to a rail connector assembly with a boom assembly, according to aspects of the present disclosure.

FIG. 2 is a perspective view of the boom assembly of FIG. 1, including a boom and a boom tip.

FIG. 3 is a front view of an example of the boom of FIG. 2.

FIG. 4 is a cross-sectional view of the example boom of FIG. 3.

FIG. 5 is a cross-sectional view of another example of the boom of FIG. 2.

FIG. 6 is a cross-sectional view the boom shown in FIG. 5.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of ±10% in the stated value.

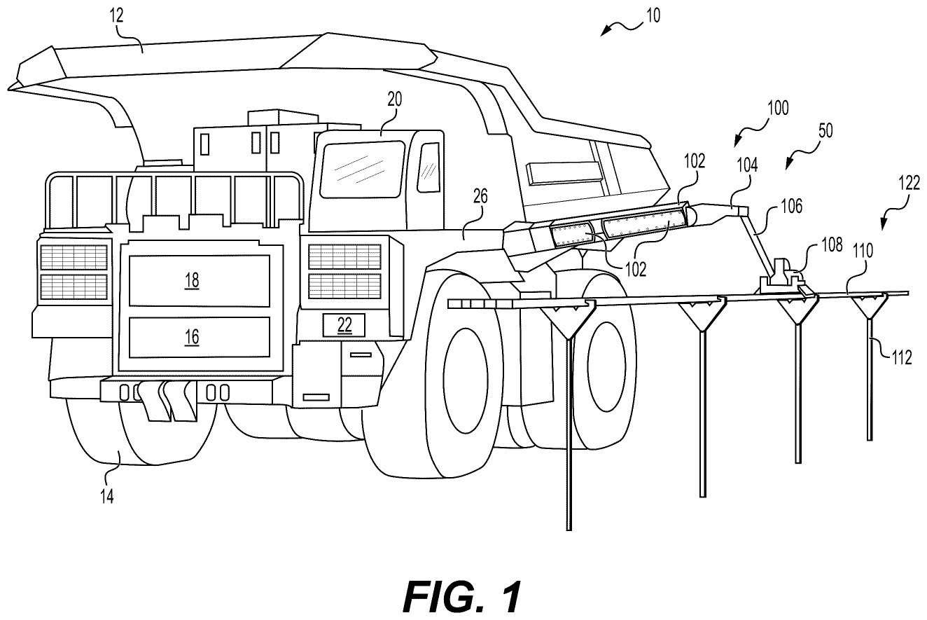

FIG. 1 is a perspective view of a mobile industrial machine 10 having a boom assembly 100, according to aspects of the present disclosure. Mobile machine 10 may be an electrically-powered machine. As used herein, the phrase “electrically-powered” includes machine systems that are entirely electric as well as partially-electric or “hybrid” machine systems. An energy storage system, e.g., a battery system may or may not be included in mobile machine 10.

As shown in FIG. 1, mobile machine 10 may include a front or forward end, a rear or back end, an implement, such as a bed 12, ground-engaging devices for propulsion, such as wheels 14 or tracks, one or more electric motors 16 for propelling mobile machine 10 (directly or via a hydrostatic transmission), and may include an energy storage system 18 including energy storage devices (e.g., batteries). In a hybrid machine 10, an internal combustion engine 22 is included to assist with propulsion and/or generation of electric power. Internal combustion engine 22 is omitted in an entirely electric machine 10. A frame 26 supports propulsion systems and other components of mobile machine 10.

Mobile machine 10 may be a free-steering machine, such as a mining haul truck, as shown in FIG. 1. Other suitable machines include, for example, articulated trucks, earthmoving machines, mining machines, paving machines, or other machines. Mobile machine 10 is configured to be operated by an operator in a cabin 20. In other examples, mobile machine 10 is operated in semi-autonomous or fully-autonomous modes.

Mobile machine 10 may include a boom assembly 100 having a boom 102, an adapter portion formed as a boom tip 104, and a rail connector assembly 50. Boom assembly 100 may facilitate electrical connection between one or more electrical systems of mobile machine 10 and a rail assembly 122, allowing transfer of electrical energy from rail assembly 122 to one or more electric motors 16, energy storage system 18, or to help power, charge, or otherwise supply electrical energy from rail assembly 122 to mobile machine 10. In particular, a trailing arm assembly 106 and conductor assembly 108 of rail connector assembly 50 may be configured to extend from an end of boom assembly 100 to contact rail assembly 122.

Rail assembly 122 may include conductive rails 110 that are shaped to receive conductor assembly 108. Conductive rails 110 may be supported by support posts 112. Conductive rails 110 may be energized by a source of electrical power (not shown). Examples of a source of power for providing electrical energy to conductive rails 110 include a power grid, generators, and/or energy storage devices.

FIG. 1 shows an example with three conductor rails 110. However, rail assembly 122 may contain fewer or more rails 110. In the illustrated example, two of the conductor rails provide electrical power at different polarities while the third conductor rail provides a reference of 0 volts. The electrically-conducting rail system may alternatively incorporate a three-phase power system, utilizing a three-rail power circuit in addition to a fourth conductor rail providing a reference of 0 volts.

Support posts 112 are configured to act as a ground for electrically-conducting rail system 122, contacting a rail to provide the reference of 0 volts described above. Individual support posts 112 may be rods, poles, posts, cylinders, stanchions, or other structures and have a length for elevating and supporting conductor rails 110, at a height of at least eight feet above the ground, for example.

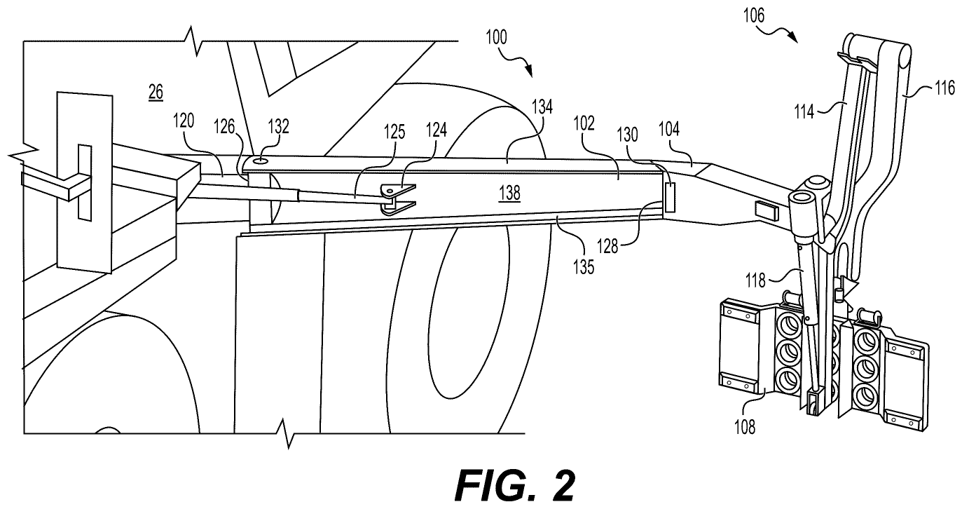

Boom assembly 100 may be configured to pivot towards and away from frame 26 of mobile machine 10 while supporting rail connector assembly 50. In particular, boom assembly 100 may pivot and transition from a collapsed or folded position against frame 26 of mobile machine 10 to an expanded position shown in FIG. 2. The expansion and retraction of boom assembly 100 is controlled by an operator in cabin 20 or in an automated manner (e.g., based on a known location of mobile machine 10 and rail assembly 122, by identifying rail assembly 122 with a vision system of mobile machine 10, by communicating with a beacon on or proximate rail assembly 122, etc.).

FIG. 2 is a perspective view illustrating boom 102 and boom tip 104 when in the expanded position. Boom assembly 100 may include a plurality of segments, boom 102 forming a first segment connected to machine 10 via frame bracket 120, and boom tip 104 forming a second segment extending from boom 102 to trailing arm assembly 106. As indicated above, boom tip 104 may form an adapter, a particular shape for boom tip 104 being selected based on the particular mobile machine 10 and/or trailing arm assembly 106 in use.

Boom 102 extends from a first end 126 to an opposite second end 128. Boom 102 is pivotally connected to frame bracket 120 at pivot 132 and is fixedly connected to boom tip 104 at second end 128. In other examples, boom tip 104 forms a pivotal joint at second end 128. In either a fixed or pivotal configuration, boom tip 104 is removably attached to boom 102, allowing boom 102 to be used with different types of machines 10. A linear actuator 125 (e.g., a hydraulic cylinder) is shown for pivoting boom 102 about pivot 132 by pulling or pushing connection flange 124 of boom 102. A rotary actuator 130 is shown connected at second end 128 for pivoting boom tip 104 with respect to boom 102. In other configurations, actuator 125 is a rotary actuator and/or actuator 130 is a linear actuator.

Trailing arm assembly 106 is connected to an end of boom tip 104. Trailing arm assembly 106 may include a proximal link 114 and a distal link 116 for positioning conductor assembly 108 below boom assembly 100 for contacting rail assembly 122. Conductor assembly 108 is positioned by use of one or more actuators, including an actuator 118, which is a hydraulic cylinder in the configuration shown in FIG. 2.

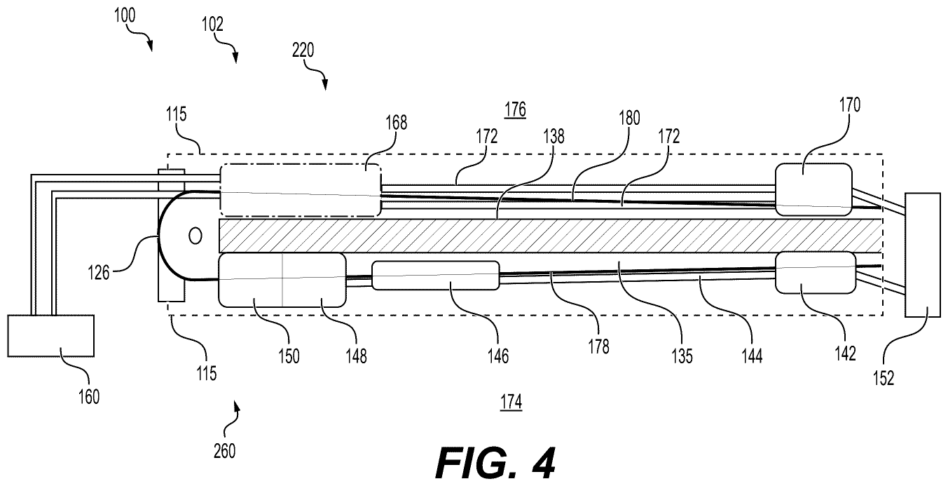

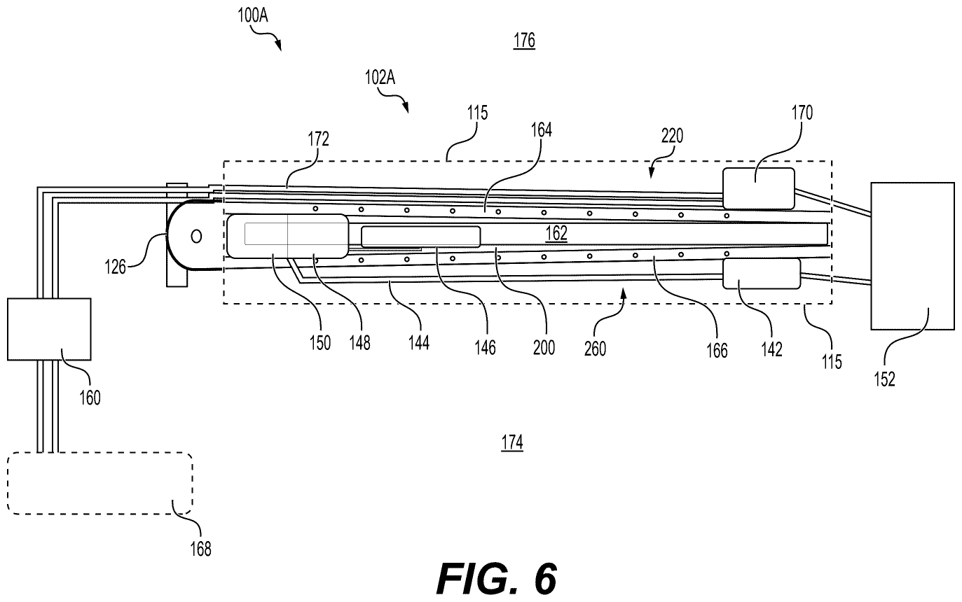

Mobile machine 10 and/or boom assembly 100 may include components of a hydraulic system 220 (FIGS. 4 and 6) for operating actuator 125, actuator 130, actuator 118, or other components. Hydraulic system 220 is an example of an actuator system. In particular, hydraulic system 220 may control one or multiple functions of conductor assembly 108, including orientation of conductor assembly 108, deployment and retraction of electrical contactors, grasping devices, etc.

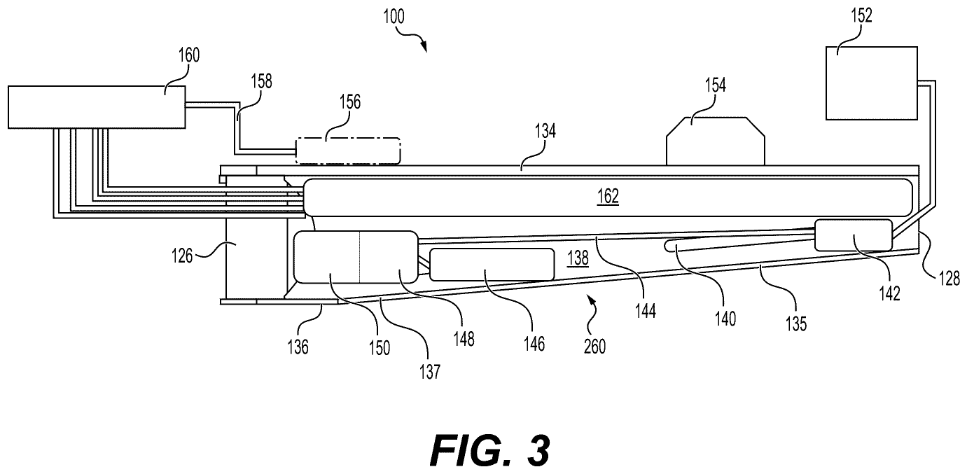

A pneumatic system 260 (FIGS. 3-6) may perform one or more of the above-described functions of hydraulic system 220 or other functions. Pneumatic system 260 is another example of an actuator system. For example, pneumatic system 260 may control orientation, deployment and retraction of electrical brushes, grasping devices for securing conductor assembly 108 to conductive rails 110, etc. One or more components of pneumatic system 260 may be positioned on machine 10, if desired. In some examples, an entirety of hydraulic system 220 and/or pneumatic system 260 is positioned away from frame 26 and instead on boom assembly 100 and trailing arm assembly 106.

Boom assembly 100 is configured to carry and protect one or more components of a system for transferring electrical energy, one or more components for monitoring conditions of boom assembly 100 (e.g., an electronic control module or sensor), one or more components of hydraulic system 220, and/or one or more components of pneumatic system 260. FIGS. 3-6 illustrate example configurations of boom assembly 100, in particular boom 102, for supporting these hydraulic, pneumatic, and electrical components.

FIG. 3 is a front view of boom 102, with schematic representations of a trailing arm interface 152, representing connections to trailing arm assembly 106, and a machine interface 160, representing connections to mobile machine 10. As shown in FIG. 3, boom 102 is an elongate member extending from first end 126 to second end 128. In this example, boom 102 has the shape of an I-beam (also shown in FIG. 2), with a central wall 138 extending from a top wall 134 to a bottom wall 135. Top wall 134 and bottom wall 135 may be generally flat plates that extend laterally outward from respective top and bottom ends of central wall 138, thus forming compartments or enclosures on each side of the central wall, as shown.

As used herein, a “central” wall may extend through a center of boom 102 as measured in a front-to-rear direction (a horizontal direction) or may be offset. For example, a “central” wall 138 may be closer to a front edge 178 (FIG. 4) or a rear edge 180 (FIG. 4) of the top or bottom wall 134, 135. Central wall 138 may include one or more openings 140 for weight reduction, wire or conduit routing, etc.

As shown in FIGS. 3 and 4, components may be mounted to central wall 138, top wall 134, or bottom wall 135. In particular, components for electrical connections, such as an insulated busbar 162 for transferring electrical energy from conductive rails 110 to electrical components of mobile machine 10, may be fixed in place to central wall 138. While a solid conductor, insulated busbar 162, is shown in FIGS. 3 and 4, suitable electrical connections also include electrical cables, connectors, and other components. For example, insulated electrical cables may be connected to one or both ends of busbar 162 or other solid conductors. In some configurations, flexible cables may be placed on boom 102 instead of a solid conductor such as busbar 162. As shown in FIG. 3, insulated busbar 162 may be connected underneath top wall 134. In some examples, insulated busbar 162 does not protrude beyond top wall 134 in a front-rear direction, in a lateral direction, or in a vertical direction, allowing top wall 134 to cover an entirety of insulated busbar 162. As described below, at least one component of hydraulic system 220 or pneumatic system 260 may protrude outward from walls 134, 135.

As shown in FIG. 4, central wall 138 may divide boom 102 into a front side 174 and a rear side 176, front side 174 being a side that faces machine 10 when boom assembly 100 is collapsed or stowed position against frame 26 of mobile machine 10. Thus, components connected to rear side 176 may be accessible from outside of mobile machine 10 when boom assembly 100 is collapsed against frame 26, facilitating maintenance or replacement of these components without actuating boom assembly 100.

Examples of components that protrude outward on front side 174 beyond edges 178, 180 of walls 134, 135 include a pneumatic valve 142, a pneumatic tank 146 (e.g., for pressurized air), a pneumatic compressor 148, and a pneumatic dryer 150. Generally, components positioned closer to front side 174 than rear side 176 may require less frequent maintenance and/or be more robust, and are therefore suitable to face machine frame 26 when boom 102 is collapsed and face a direction of forward travel of machine 10. Components that protrude outward on rear side 176 beyond edges 178, 180 include a hydraulic valve 170, and if present, a hydraulic power unit (HPU) 168, such as a hydraulic pump. Electrical conductors and hoses for pneumatic system 260 and hydraulic system 220, including electrical line 158, hydraulic line 172, and pneumatic line 144, may be covered entirely by top wall 134 until extending beyond first end 126 or second end 128.

As shown in FIG. 3, one or more components may be connected above top wall 134, for example by being secured to an upper surface of top wall 134. A lock mechanism 154 such as a protrusion shaped to mate with a corresponding receptacle on the frame 26 of mobile machine 10 may protrude from top wall 134. If present on boom assembly 100, an electronic control module (ECM) 156 may also be connected to top wall 134. Electronic control module 156 may be connected to one or more sensors of hydraulic system 220 or pneumatic system 260 (e.g., pressure sensors, flow sensors), one or more position sensors (e.g., proximity sensors, rotary sensors), or one or more electrical sensors (e.g., current sensors, voltage sensors) to monitor conditions of boom assembly 100 and trailing arm assembly 106. ECM 156 may be configured to control actuation of hydraulic or pneumatic-driven components based on feedback from these sensors. Placement of electronic control module 156 on top wall 134 may facilitate connections to machine interface 160 via electrical line 158 or improve accessibility of ECM 156 for maintenance and/or communication with an external system via access when boom assembly 100 is stowed. If desired, electronic control module 156 may instead be connected under top wall 134.

As represented by dashed lines in FIG. 4, boom 102 may include a cover panel 115 on front side 174 and an additional cover panel 115 on rear side 176. Each cover may have a “U” shape, with ends of the “U” being connected at top wall 134 and bottom wall 135. The protruding center of the “U” shape may cover the above-components housed in boom 102, protecting these components from moisture, wind, dust, and debris.

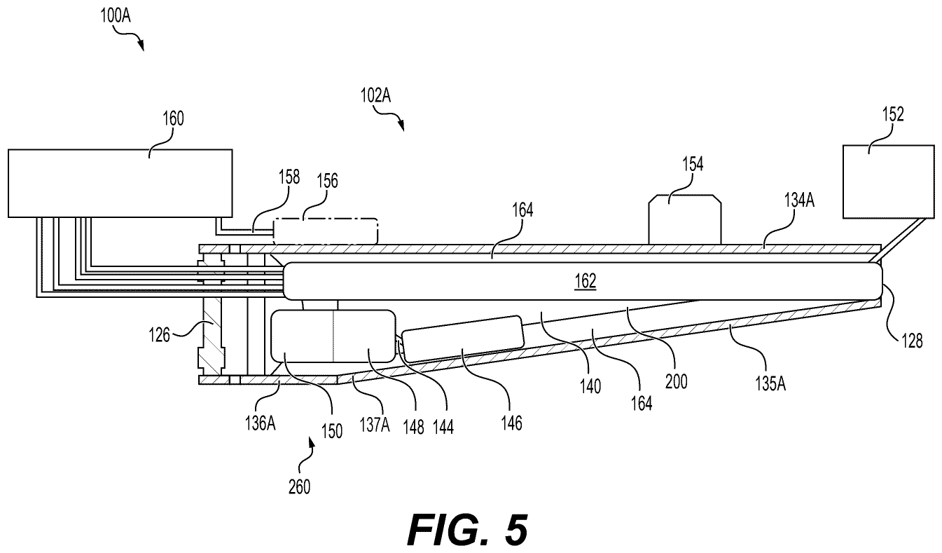

FIG. 5 is a cross-sectional view showing another example of boom 102A, an alternate configuration of boom 102. In the example of FIG. 5, also shown in FIG. 6, boom 102A is formed with a box-beam construction defined with a top end, a bottom end, a front end, and a rear end, forming an enclosure 200. With reference to FIG. 5, the top end is formed with top wall 134A and the bottom end is formed with a bottom wall 135A. The front and rear ends of enclosure 200 are formed with a front side plate 166 (FIG. 6) and a rear side plate 164 (FIG. 6). If desired, plates or other members may be provided to partially or entirely close first end 126 and second end 128.

Enclosure 200, formed with top wall 134A, bottom wall 135A, and side plates 164, 166 may contain one or more components, such as the electrical, hydraulic, or pneumatic components described above. Enclosure 200 may include one or more one or more openings 140 (e.g., through-holes extending through front side plate 166 and rear side plate 164). One or more additional components may be located partially, or entirely, outside of enclosure 200. While a single, continuous enclosure 200 is illustrated, if desired, enclosure 200 may be divided into one or more additional compartments. For example, insulated busbar 162 may be placed in one compartment, while other components are placed in other, separate compartments. This may improve safety by allowing a portion (e.g., a compartment) of enclosure 200 to be covered with a cover panel 115 that is locked and not readily removable by a user, preventing user access to high-voltage components such as insulated busbar 162. In particular, one or more cover panels 115 that enclose busbar 162 may prohibit access to busbar 162 unless opened or removed with a particular tool. When busbar 162 is connected to electrical cables or other electrical connections, these connections may be placed within a compartment that is sealed with a cover panel 115 that is locked until opened with a particular tool.

An electrical component, such as insulated busbar 162, may be centrally located within the enclosure in a front-to-rear direction, as shown in FIG. 6. Insulated busbar 162 may be attached to a lower surface of top wall 134A, for example. In other examples, insulated busbar 162 is secured off-center with respect to the front-to-rear direction and is attached directly to rear side plate 164 or front side plate 166.

Pneumatic tank 146, pneumatic compressor 148, pneumatic dryer 150, pneumatic line 144, and other components of pneumatic system 260 may be located within enclosure 200. Other components, such as lock mechanism 154 and electronic control module 156 (FIG. 5) are located entirely outside enclosure 200. Other components that may be suitable for placement entirely outside enclosure 200 include hydraulic valve 170 and pneumatic valve 142 (FIG. 6), as well as one or more hydraulic lines 172 or pneumatic lines 144. In some examples, hydraulic components are located within enclosure 200 and/or pneumatic components are located outside of enclosure 200. Components that are more frequently adjusted, replaced, or components that are periodically inspected or maintained may be placed outside of enclosure 200.

FIG. 6 shows an example where HPU 168 is located outside of boom 102. In particular, HPU 168 may be located on mobile machine 10, with hydraulic line 172 providing hydraulic fluid via machine interface 160 via one or more hydraulic valves 170 placed on boom 102. If desired, other components of the hydraulic system (e.g., hydraulic valve 170) may also be located on mobile machine 10 and not on boom assembly 100. If desired, one or more hydraulic lines 172 may be the sole hydraulic component secured within boom 102A, with other components of hydraulic system 220 being located on machine 10. While hydraulic power unit 168 is illustrated in FIG. 4 as being positioned on boom 102, if desired, the example shown in FIG. 4 may also be configured in this manner by positioning hydraulic components other than lines 172 on machine 10.

With reference to FIG. 6, one or more components may be placed at different heights so as to overlap each other along a vertical direction within enclosure 200. For example, pneumatic tank 146, pneumatic compressor 148, and pneumatic dryer 150 may overlap insulated busbar 162. Insulated busbar 162 may be located above pneumatic tank 146, pneumatic compressor 148, and pneumatic dryer 150, as shown in FIG. 6. If desired, one or more other components may overlap insulated busbar 162, such as electronic control module 156 or components of hydraulic system 220.

As shown in FIGS. 3 and 5, boom 102 may have a shape at which first end 126 forms a widened end when measured in a vertical direction from top wall 134, 134A to bottom wall 135, 135A. A flat wall portion 136, 136A extends from first end 126, the flat wall portion 136, 136A forming a part of bottom wall 135, 135A. A tapering portion of bottom wall 135, 135A may extend from flat portion 136, 136A toward second end 128, a height of boom 102, measured by the distance from top wall 134, 134A to bottom wall 135, 135A decreasing towards second end 128. A tapering shape that narrows away from mobile machine 10 (e.g., toward second end 128) may be beneficial, for example by placing loading closer to machine 10 and reducing the torque acting on first end 126. However, boom 102 may be formed without a taper or with a shape that tapers toward first end 126.

As shown in FIGS. 4 and 6, boom 102, 102A may have a shape which tapers from a horizontal direction, the front-to-rear direction measured from front edge 178 to rear edge 180. In the example of FIG. 4, this taper may result in a gradual reduction in the width of top wall 134, 134A and of bottom wall 135, 135A. In examples where no taper is formed in the front-to-rear direction, top wall 134, 134A and bottom wall 135, 135A may each have a substantially rectangular shape when viewed from above.

### INDUSTRIAL APPLICABILITY

The disclosed boom assembly 100 may be used with multiple types of mobile industrial machines 10 to supply electrical energy from a rail assembly 122 positioned to a side of mobile machine 10. One or more components of boom assembly 100, such as boom 102, 102A can be used in multiple machine types with minimal or no design changes. A machine or application specific boom tip 104 and/or trailing arm assembly 106 is attached to boom 102, 102A according to the particular mobile machine 10.

During operation of mobile machine 10, boom assembly 100 may be configured to extend and retract, in response to an input from an operator or to a command from an autonomous system controller. Boom assembly 100 is retracted when charging is not necessary and/or when a rail assembly 122 is not adjacent to mobile machine 10. Boom assembly 100 is extended via hydraulic system 220 (e.g., HPU 168, hydraulic valve 170, hydraulic line 172) within frame 26 and/or components of hydraulic system 220 supported with boom assembly 100. Trailing arm assembly 106 is actuated from a folded position (FIG. 2) to an extended position (FIG. 1) by the hydraulic and/or pneumatic systems 220, 260. Once in contact with conductive rails 110, conductor assembly 108 is configured to supply electrical energy to mobile machine 10 while mobile machine 10 is in motion.

In examples where hydraulic power unit 168 is located on machine 10, hydraulic fluid from HPU 168 is supplied to hydraulic lines 172 (e.g., four, six, eight, ten, or twelve lines 172) secured to boom 102, 102A. At least some of the hydraulic lines 172 may extend beyond second end 128 to control functions of trailing arm assembly 106. In other examples, HPU 168 supplies hydraulic fluid from a position on boom 102, 102A. When pneumatic system 260 is present, components for generating pressurized air, e.g., pneumatic compressor 148, may similarly be located on mobile machine 10, with pneumatic lines 144 (e.g., four, six, eight, ten, or twelve lines 144) secured to boom 102, 102A and extending beyond second end 128.

The above-described boom assembly 100, including boom 102, 102A provides a stable construction for supporting electrical components and components for actuating boom assembly 100 or a trailing arm assembly. Components for controlling features of boom assembly 100 and rail connector assembly 50 are protected, with components being positioned in a manner that facilitates accessibility in states where boom assembly 100 is extended or collapsed. The use of an I-beam or box beam construction provide internal space for mounting components, while increasing rigidity and reducing deflection of boom 102, 102A. The shape of boom 102, 102A such as a symmetric design when viewed from above, allow boom 102, 102A to be used on either side of mobile machine 10. The ability to use a single, modular design for boom 102, 102A may reduce costs, improve manufacturability, and facilitate maintenance.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A boom assembly for a mobile machine having a front end and a rear end, the boom assembly comprising:
an extendable and retractable boom including:
a first end;
a second end;
a top wall extending from the first end to the second end;
a bottom wall extending from the first end and the second end, the bottom wall being opposed to the top wall; and
a central wall connecting the top wall and the bottom wall, so as to form a front compartment on one side of the central wall, and a rear compartment on a second side of the central wall, when the boom is in an extended position; and
a component of an actuator system connected to the central wall and located within the rear compartment.

2. The boom assembly of claim 1, wherein the actuator system includes a hydraulic system and the component is a hydraulic valve, a hose, or pump of the hydraulic system.

3. The boom assembly of claim 2, wherein high voltage components are located in the front compartment, and in the retracted position of the boom, the front compartment faces a frame of the mobile machine.

4. The boom assembly of claim 3, wherein the component includes a hydraulic hose configured to connect to a hydraulic pump located on the mobile machine.

5. The boom assembly of claim 3, wherein the high voltage components include an insulated busbar connected to the central wall.

6. The boom assembly of claim 1, wherein the central wall is offset with respect to the top wall and the bottom wall.

7. The boom assembly of claim 6, further including a cover connected to the front compartment of the boom or the rear compartment of the boom to at least partially close off the respective compartment.

8. The boom assembly of claim 1, further including a lock on the top wall, the lock being configured for locking the boom to a side of the mobile machine.

9. The boom assembly of claim 1, wherein a portion of the component extends away from the central wall so as to protrude beyond an edge of the top wall or an edge of the bottom wall of the rear compartment.

10. The boom assembly of claim 1, further including a cover, the cover being connected to the boom over at least a portion of the rear compartment such that the component is positioned between the cover and the central wall.

11. An electrically-powered mobile machine having a front end and a rear end, comprising:
at least one motor configured to propel the mobile machine;
a conductor assembly configured to connect to an electrically-conductive rail for supplying electrical energy to propel the mobile machine; and
an extendable and retractable boom including:
a first end;
a second end;
a top wall extending from the first end to the second end;
a bottom wall extending from the first end and the second end, the bottom wall being opposed to the top wall; and
a central wall connecting the top wall and the bottom wall, so as to form a front compartment on one side of the central wall, and a rear compartment on a second side of the central wall, when the boom is in an extended position;
a hydraulic component associated with the conductor assembly connected to the central wall and located within the rear compartment; and
a high voltage component associated with the conductor assembly connected to the central wall and located within the front compartment.

12. The mobile machine of claim 11, wherein the hydraulic component is at least one of a hydraulic valve, a hose, or pump of a hydraulic system.

13. The mobile machine of claim 12, wherein, in a retracted position of the boom, the front compartment faces a frame of the mobile machine.

14. The mobile machine of claim 13, further including a cover connected to the front compartment of the boom and the rear compartment of the boom to at least partially close off the front and rear compartments.

15. The mobile machine of claim 13, wherein the central wall is offset with respect to the top wall and the bottom wall.

16. A boom assembly for a mobile machine, the boom assembly comprising:
a boom including:
a first end;
a second end;
a top wall extending from the first end to the second end;
a bottom wall extending from the first end and the second end, the bottom wall being opposed to the top wall;
a connecting wall connecting the top wall and the bottom wall; and
at least one enclosure formed by the top wall, the bottom wall, and the connecting wall; and
a component associated with a conducing assembly connected to the boom, the component being connected to the top wall, the bottom wall, the front wall, or the rear wall and secured inside the enclosure.

17. The boom assembly of claim 16, further including an additional component associated with a conducting assembly being secured on the boom outside of the enclosure.

18. The boom assembly of claim 16, wherein the component a high voltage component.

19. The boom assembly of claim 18, further including a removable cover positioned over the component at a front side or a rear side of the boom.

20. The boom assembly of claim 16, wherein the component is a hydraulic component connected to a hydraulic power unit that is not secured to the boom.
